(19) United States
(12) Patent Application Publication
(10) Pub. No.: US 2017/0364064 A1
(43) Pub. Date: Dec. 21, 2017

(54) MONITORING AN INDUSTRIAL PRODUCTION LINE VIA TARGETED EXCHANGES

(71) Applicant: GEBO CERMEX CANADA INC., Laval (CA)

(72) Inventors: Franck KLOTZ, LAVAL (CA); Marie HUFFENUS, Mundolsheim Cedex (FR); Pierre Yves SCHAAL, Mundolsheim Cedex (FR); Laurent LAXAGUE, Mundolsheim Cedex (FR)

(21) Appl. No.: 15/540,915

(22) PCT Filed: Dec. 30, 2014
(86) PCT No.: PCT/IB2014/002896

§ 371 Date: Jun. 29, 2017

(51) Int. Cl. G05B 23/02; G08B 3/10

(52) U.S. Cl. CPC G05B 23/0272; G08B 3/10

(57) ABSTRACT

Disclosed is a method for managing an industrial production line, including at least one processing station and one monitoring station that is connected to the at least one processing station. The method includes: sending a radiofrequency signal from the monitoring station to a communication peripheral; then—sending a corresponding sound signal using the communication peripheral. The sound signal is dedicated to an operator to which the peripheral is assigned. The transmitted information is specific to the communication peripheral. Also disclosed is a corresponding device and facility.

This invention relates to the field of the monitoring and control of an industrial line for processing products, and has in particular as its object a device and a method for monitoring such a line as well as a corresponding installation.

This invention is applied specifically to the chain processing of products by successive different processing stations, where it is necessary to monitor the operation of each station or transition for the purpose of avoiding adversely affecting the operation of the entire line.

Such a line can be in particular a production line and then a packaging line, in which products of the bottle, jar, or other food product type are filled and then gathered to be, ultimately, arranged in layers of groups of products on a pallet.

Different events can occur in the operation of such a line, and it is then important, to avoid adversely affecting the overall efficiency of the line, to notify quickly an operator who will be able to intervene, solve the problem, and either pre-empt a stoppage or put the line or the machine affected in running order. Of course, the communication of information is not limited to malfunction situations.

By way of example, GB2341458 discloses a line monitoring tool that makes it possible to recover and use data that are representative of the operation of a station.

US2002198686 then proposes, for example, a central processing unit that recovers warning signals that can emanate from different stations of the line. The central processing unit can also communicate with the outside.

U.S. Pat. No. 4,749,985 discloses the generating of acoustic alarm signals, which is a widely-used solution today. In case of failure on a station of the line, an acoustic signal is generated within the machine, generally accompanied by a local visual signal. A central readout can, in addition, collect the signals and instantaneously report visually the operating status of the entire line.

Such a manner of reporting the operation of the line is not, however, ideal, because of generating a possible large amount of noise pollution that can, if necessary, mask the important sound alerts. It is no longer possible to have the specific and dedicated information distributed. In addition, the operator must constantly keep in his field of vision the central panel that visually reports the operating status of the line.

Further, an operator must, in most cases, move within the area of the processing station in order to know its operation.

In view of these needs to improve the tools for monitoring an industrial processing line, the invention proposes putting a wireless communication in place between a line management central processor, which follows its operation, and a mobile device able to generate sound messages, optionally voice, bound for an operator, to establish a voice communication of information from the line, even a two-way exchange.

The invention thus has as its object a method of industrial line management for chain processing of products comprising at least one processing station and a control center connected to at least one station, a method comprising a step that essentially consists in collecting from at least one station information that is representative of its operation and in communicating it to the control center.

This method is characterized in that

it comprises steps essentially consisting in

transmitting a radiofrequency signal from the control center and to a communication peripheral, and then

emitting a corresponding acoustic signal, using the communication peripheral,

the acoustic signal being dedicated to an operator to whom said peripheral is assigned,

the information conveyed belonging to the communication peripheral.

The invention also has as its object a device using the method, namely a device for monitoring a line for chain processing of products with at least one processing station, comprising a control center for at least collecting data relating to the processing by at least one station and a database to store at least data representative of the operation of the processing line. This device is characterized in that

the control center comprises a signal communication base, to at least transmit radiofrequency signals concerning information relating to the line,

the monitoring device further comprises at least one communication peripheral, to receive from said communication base a radiofrequency signal, said communication peripheral being provided with an acoustic emitter to make messages concerning the operation of the line audible, and this in a targeted way to a line operator to whom said peripheral is assigned.

The invention further has as its object a chain processing installation for products comprising a series of stations forming a processing line, the stations being associated in groups, each comprising at least one station, said installation being characterized in that it further comprises a monitoring device such as described above, whose control center is connected to the stations of the line to collect and analyze data relative to their operation within a server that comprises said central processor,

said monitoring device being equipped with a plurality of communication peripherals.

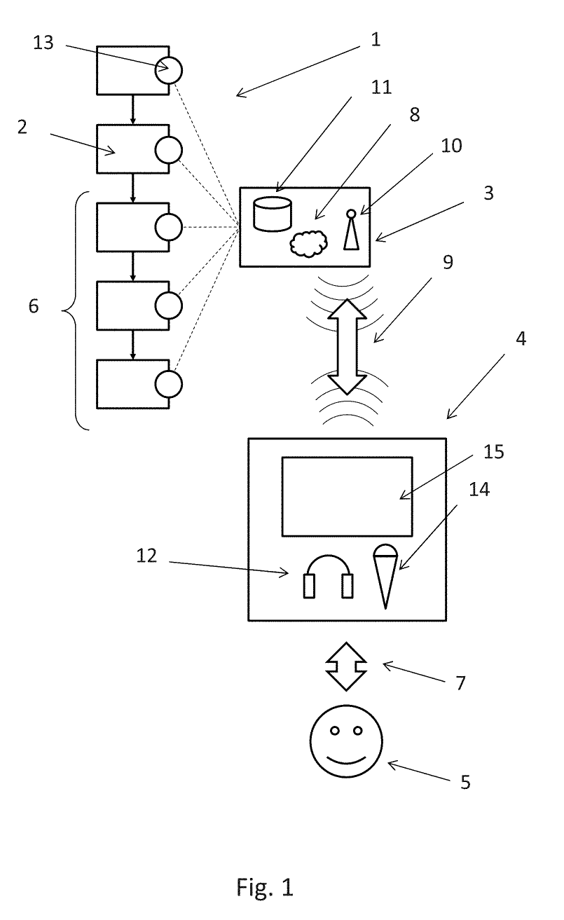

The invention will be better understood as a result of the description below, which is based on possible embodiments, explained in a way that is illustrative and in no way limiting, with reference to FIG. 1 that diagrams a type of possible structure.

The invention, first of all, thus has as its object a method for industrial line 1 management for chain processing of products that comprises at least one processing station 2 and a control center 3 connected to at least one station 2, a method comprising a step consisting essentially in collecting from at least one station 2 information that is representative of its operation and in communicating it to the control center 3. For this purpose, detection means 13 are provided to check on predefined criteria in the area of the line 1, in particular in the area of the stations 2. It is, of course, possible to have detection means 13 that check on the operation of a piece of equipment between two stations 2.

According to the invention, this method comprises steps consisting essentially in

transmitting a radiofrequency signal 9 from the control center 3 and to a communication peripheral 4, and then

emitting a corresponding acoustic signal, using the communication peripheral 4,

the acoustic signal being dedicated to an operator 5 to whom said peripheral is assigned,

the information conveyed belonging to the communication peripheral 4, preferably taking into account a configuration of the latter. The information conveyed is therefore specific to the communication peripheral 4.

The acoustic signal emitted by the communication peripheral 4 corresponds to the radiofrequency signal 9 transmitted by the control center 3 and has a very slight volume so as not to cause a noise disturbance for operators 5 who are not affected. It is, for example, possible to emit the acoustic signal from an ear piece that the operator 5 wears under noise-cancelling headphones. Generally, the acoustic signal is therefore produced so as essentially to be received only by the operator 5 with whom the communication peripheral 4 that emits it is associated. Therefore, it does not involve a signal that is audible to all of the individuals present around the line 1.

The conveyed information belongs to the communication peripheral 4 that produces the corresponding acoustic signal, and it is therefore possible to use the same control center 3 to have different exchanges in terms of contents with different communication peripherals 4.

The communication peripheral 4 is actually assigned to a line operator 5 and must therefore convey only the messages that contain a piece of information that is useful for the line operator 5, as a function of the responsibilities of the latter, i.e., essentially as a function of the group 6 of stations 2 for which it must ensure supervision. Of course, the operator 5 can also be a supervisor of the entire line 1, concerned in this case with information of another nature, and then relating to all of the stations 2. A line operator 5 can thus be in charge of a group 6 of stations 2 of the line 1, said group 6 comprising at least one station 2, indeed all of the stations 2 of the line 1, when the line operator 5 is a supervisor, for example.

The line operator 5 therefore is not concerned with the entirety of the information that it is possible to produce as a result of monitoring the line 1, and the acoustic messages produced by the communication peripheral 4 that is assigned to him must therefore report only information of interest to this operator 5, which makes it possible to prevent the operator 5 from getting used to receiving information that does not require processing. It should be noted that it remains possible to send the same message to all of the communication peripherals 4, particularly when this message concerns all of the operators 5.

Using a radiofrequency signal 9 rather than a wire communication makes it possible for the line operator 5 who wears the communication peripheral 4 to move away from the group 6 under his supervision, and using an acoustic message allows him the possibility of using his eyes for other activities. Further, as will be described below, it is possible to use an acoustic signal in the form of an acoustic voice message 7 that then makes it possible to enhance the conveyed information.

The information transmitted preferably relates to the operation of the line 1, and can be alert messages, preventive messages, or remedy messages, reports on the situation, etc. Their transmission is preferably decided by the control center 3, on the basis of a logic calculation performed taking into account the data observed on the line 1.

In possible embodiments, the acoustic signal transmission comes down to the reading, by the communication peripheral 4 and using a browser software, a digital file adapted to such software and exchanged with the control center 3, particularly of the HTML encoded type. The communication peripheral 4 is therefore equipped with a processor and is able to have a software application operate that can browse in a network of files, of the web browser type. This makes it possible to exchange with the control center 3 the digital data encoded by the radiofrequency signal 9.

According to a possible additional characteristic, the acoustic signal is obtained by selection from a library of pre-recorded messages in the form of encoded digital files, representing acoustic messages, particularly in the form of acoustic voice messages 7, the library being able to be stored in a database 11 in the area of the control center 3, even in the area of the communication peripheral 4, the selection taking place preferably on the basis of the event triggering the communication of information. Thus, for example, a shortage happening in the area of a station 2 will be passed on by the associated detection means 13, then will trigger the selection, within a database 11, of a message that corresponds to this situation, the transmission of this message by this station 2 to at least one concerned communication peripheral 4, and then the production of a corresponding audio signal dedicated to the wearer of said at least one peripheral. This audio signal can be a particular ring-tone, even an acoustic voice message 7.

Actually, in certain embodiments, the acoustic signal emitted by the communication peripheral 4 to the operator 5 who is wearing it is an acoustic voice message 7, obtained optionally by artificial voice synthesis within the control center 3 or even within the communication peripheral 4, and this particularly on the basis of data registered in the database 11, so as to be able to convey to the operator 5 a more enhanced piece of information, but also more suited to the specific situation observed on the line 1 and that will have triggered, in accordance with a calculation rule of the control center 3, the flow of information to the communication peripheral 4 or to the user group of peripherals.

The digital file corresponding to the acoustic voice message 7 can be generated on a case-by-case basis in the area of the control center 3, as a function of data observed on the line 1 by the detection means 13, such as quantities produced, conditions of supplies, etc. The file is then made available on the server 8 of the control center 3 for a communication to the peripherals 4 concerned.

According to a possible additional characteristic, the acoustic signals that are emitted by the communication peripheral 4 depend on a configuration that is specific to it and that defines the type of information from which the signal must be identified to be acoustically produced and thus be audible to the operator 5 with whom the communication peripheral 4 is associated, so that only messages whose purpose is consistent with the specific configuration of the communication peripheral 4 are emitted by the latter. This is not a matter of a technical configuration linked to the file coding or to the technical compatibility of the equipment used. On the contrary, it is a matter of specifying the type of information or the type of message that can be reproduced by each communication peripheral 4. It is therefore as a function of the content of the message that it is played or not by the communication peripheral 4. Each communication peripheral 4 is therefore configured, and the control center 3 generates files bound for each communication peripheral 4 connected to it, as a function of the content in which it is interested.

Preferably, defining the configuration of the communication peripheral 4 takes place using an interface with which it is itself equipped, particularly a control interface, of the touch interface type within a module 15, by cursor, keyboard, or the like. Further, advantageously, the configuration of the communication peripheral 4 is stored within the control center 3, preferably within a server 8 with which it is provided.

According to a possible additional characteristic, in terms of communication network structures that form, on the one hand, the control center 3, and, on the other hand, the group of the communication peripherals 4, the communication peripheral 4 is an identified client, in association with a server 8 of the control center 3, the server 8 generating a flow of information that relates to the line 1 and that is specific to the communication peripheral 4.

The flow of information is preferably generated within the server 8 and sent in the form of a digital radiofrequency signal 9 to the communication peripheral 4. Messages dedicated to each of the communication peripherals 4 are thus particularly produced within the server 8, as a function of the information with which each is concerned considering its configuration, as long as the corresponding situation is detected by the control center 3 within the line 1.

In possible embodiments, the method comprises a step consisting essentially in sending a message by radiofrequency signal 9 from a communication peripheral 4 and to the control center 3, to make it possible for the line operator 5 to use the communication peripheral 4 to send calculation requests to the server 8 and to obtain from it the result by the process described above, or else to order the sending of a message to other communication peripherals 4. This exchange therefore forms the reverse direction of the one described up to now, where it was the control center 3 that sends information bound ultimately for the operator 5. The data exchanged in one direction and then in the other can be dependent upon one another, such as, for example, for a query of the content of the database 11 by the operator 5, and then the sending of a reply. The signal sent by the peripheral 4 can also be bound for other peripherals, for example. It can be, in particular, an acoustic voice message 7 bound for them, for example.

The sending of a calculation request to the control center 3 can take place using the interface with which the communication peripheral 4 is provided, particularly a touch interface, by cursor, keyboard, or the like, etc. In particular embodiments, the method comprises a step consisting in analyzing an acoustic voice message 7 produced by an operator 5 bound for the communication peripheral 4, to create the contents of the radiofrequency signal 9 sent by the communication peripheral 4 to the control center 3. This thus makes possible the generation of requests that are specific and suited to the situation. The analysis of the content of the acoustic voice message received this time by the communication peripheral 4 can be done within said peripheral, or farther away in the exchange with the server 8.

Of course, the content of the data sent by the radiofrequency signal 9 to the control center 3 can be decided by the operator 5 using the interface of the peripheral 4. Thus, the content of the message sent by the communication peripheral 4 to the control center 3 is created from an interface with which the communication peripheral 4 is equipped, particularly a touch, keyboard, or cursor interface, which allows input.

The invention also has as its object a device for monitoring a line 1 for chain processing of products with at least one processing station 2, comprising a control center 3 for at least collecting data relating to the processing by at least one station 2 and a database 11 to store at least data representative of the operation of the processing line 1.

This device, used by the method described above, is characterized in that

the control center 3 comprises a signal communication base 10, to at least transmit radiofrequency signals 9 concerning information relating to the line 1,

the monitoring device further comprises at least one communication peripheral 4, to receive from said communication base 10 a radiofrequency signal 9, said communication peripheral 4 being provided with an acoustic emitter 12 to make messages concerning the operation of the line 1 audible, and this in a targeted way to a line operator 5 to whom said peripheral is assigned, so as to prevent the acoustic messages from being received by other operators 5 that are not involved. The acoustic signal corresponds to the data from the radiofrequency signal 9, itself corresponding to the readings from the line 1.

The acoustic emitter 12 can, in particular, be an ear piece that the line operator 5 wears under noise-cancelling headphones, said ear piece communicating wirelessly with another device or module 15 of the communication peripheral 4 that ensures the reception of the radiofrequency signal 9 from the control center 3 and the wireless transmission to said ear piece.

The communication peripheral 4 therefore forms a specifically identified client who is in communication with a server 8 that is common to the plurality of communication peripherals 4, to exchange messages that are specific to each communication peripheral 4 taking into account its configuration in terms of information with which it is concerned. The server 8 thus transmits messages by radiofrequency signal 9 that are not followed by an acoustic message within certain communication peripherals 4 that are not affected by the information contained in said message.

In possible embodiments, the communication peripheral 4 comprises a module 15 in the form of a communicating smart digital device, equipped with a processor and able to exchange wireless signals with the control center 3, using a network or web browser software tool to read corresponding digital files exchanged with the control center 3, as coded in HTML, with audio message digital data.

The module 15 also comprises, in particular, a manual, touch or cursor control interface, to make it possible for the operator 5 to send data to the control center 3. The module 15 can also comprise a display means that produces in visual form the message received from the control center 3. Said communication peripheral 4 then preferably also comprises a satellite, in communication with the module 15 and comprising the acoustic emitter 12 to produce the sound corresponding to the message exchanged with the control center 3 in the form of a sound-coding digital file, such as an MP3.

The satellite also optionally comprises a microphone 14 as a result of which the operator 5 can send data to the control center 3 by speaking, these voice data being processed between the microphone and the server 8.

Further, the communication peripheral 4 can be, for example, a telephone, operating wirelessly over a communication network, such as a private and internal network, of the communication network type of the production site that houses the line 1, or else such as a public communication network. A phone number, with a public or private format, is then assigned to the communication peripheral 4 and is dialed at the time of the sending of information from the control center 3. The communication peripheral 4 can thus be a standard cellular telephone, with which the control center 3 makes contact as needed to exchange information, preferably in both directions. The communication peripherals 4 can also be handsets of a dedicated communication network, of the walkie-talkie type.

The communication peripherals 4 thus form a network and can optionally, if applicable, exchange all information, as a result of the control center 3 through which it passes.

Finally, the invention has as its object an installation for chain processing of products comprising a series of stations 2 forming a processing line 1, the stations 2 being associated in groups 6, each comprising at least one station 2. This installation is characterized in that it comprises a monitoring device as described above, the control center 3 of which is connected to the stations 2 of the line 1 to collect and analyze data relative to their operation within a server 8 that comprises said central processor,

said monitoring device being equipped with a plurality of communication peripherals 4, each being preferably associated with a group 6 of stations 2.

In particular embodiments, a specific configuration is associated with each communication peripheral 4 and determines the type of message exchanged between it and the server 8 or a server 8 of the control center 3, the messages exchanged between the control center 3 and a communication peripheral 4 thus depending on the configuration that is associated with it and thus being able to be different from the messages exchanged with at least one other communication peripheral 4.

The invention will now be explained with reference to the accompanying figure.

In the accompanying figure, the processing line 1 comprises a plurality of stations 2, mounted in series and/or parallel, to process products as a unit or else batches of such products. Such a line 1 in particular makes possible the primary and/or secondary packaging of products, to obtain, ultimately, pallets of products packaged in cardboard boxes, for example.

Different detection means 13 are associated with the stations 2, so as to be able to monitor their operation in real time, and thus to track, for example, the number of products processed by each of them, or else different signals representative of the operation, such as the condition of the supplies, the presence or absence of product upstream or downstream, the automatic diagnostics of the cause of an interruption of normal operation, etc. These detection means 13 are connected to the control center 3, which thus recovers data representative of the state of operation of each of the stations 2 of the line 1. The control center 3 therefore comprises a server 8 that is connected to each of the stations 2 and/or each of the detection means 13. The detection means 13 can also be associated with the transitions between stations 2.

The control center 3 processes the variety of data that it receives and analyzes them, for example, to identify and/or anticipate needs for intervention, for analyzing the production on the basis of a predefined calculation logic, for generating reports, etc. The control center 3 analyzes the data received by the detection means 13, reporting on the operational state of the line 1 to implement specific behaviors as soon as predefined situations appear: triggering an alarm in case a station 2 is stopped, sending a preventive signal as soon as a supply reaches a particular threshold, communication concerning the status of the batteries between the stations 2, communication of information in a specific situation, such as, for example, upon the appearance of the triggering event, or else at a regular frequency, etc.

Here, the invention proposes communicating information, concerning problematic situations underway or upcoming, or generally concerning the operation of the line 1, as a result of a radiofrequency communication channel, making it possible for the operator 5 who must intervene or be aware of this information not to have the obligation of being nearby, the types of information exchanged with a communication peripheral 4 being predefined in advance for the communication peripheral 4 affected, said communication peripheral 4 producing, bound for the operator 5 in its immediate vicinity, an acoustic message, preferably voice, associated with this information.

Thus, the control center 3 comprises a communication base 10, for a wireless communication, particularly the transmission of a radiofrequency signal 9. It can in particular be a relay, such as the WiFi access point terminal or other Ethernet switch. The communication base 10 and the server 8 of the control center 3 can be connected by wire or not. The communication base 10 can at least transmit radiofrequency signals 9, even also receive them, as will also be described below. The communication base 10 thus ensures the wireless exchange of information with the server 8 of the control center 3.

The device also comprises at least one communication peripheral 4 at least to receive radiofrequency signals 9 from the communication base 10 of the control center 3. The communication peripheral 4 is intended to receive, by radiofrequency signal 9, information concerning the line 1, and to produce ultimately a corresponding acoustic message, preferably an acoustic voice message 7. This acoustic message, preferably voice, is loud and audible, produced in the immediate environment of the operator 5, as a result of headphones, an ear piece, or the like, which makes it possible to prevent such a signal or acoustic message from generating a noise disturbance for the environment and also to ensure better comfort for the operator because the sound is transmitted at a volume that is controlled by him and, for example, with optional hearing protection. Further, using an acoustic voice message 7 makes it possible for the operator to access enhanced information and this without obliging him to keep a visual signaling device within his field of vision.

The same communication peripheral 4 could also make possible direct exchanges between operators 5, as will be described below.

Preferably, the communication peripheral 4 comprises, on the one hand, a radiofrequency communication means, to exchange with the communication base 10 and particularly to receive the radiofrequency signals 9, and, on the other hand, connected to said means, an acoustic emitter 12, to generate the sound that can be audible to the operator and corresponding to the acoustic voice message 7. The communication peripheral 4 can thus essentially consist of a smart communication device, or module 15, of the smartphone, tablet, or even computer type, connected to headphones, such as an ear piece communicating wirelessly with this device, for example by Bluetooth.

The device preferably comprises a plurality of communication peripherals 4, each able to receive radiofrequency signals 9 concerning the operation of the line 1. A communication peripheral 4 can then be dedicated to an operator 5 in charge of a group 6 of stations 2. In this case, it is preferable not to systematically reproduce each of the potential messages within each communication peripheral 4, essentially to avoid saturating the intended operators 5 with useless information.

For example, if a communication peripheral 4 is dedicated to a certain group 6 of stations 2, making it produce sound messages relative to other stations 2 would be useless and possibly harmful. It is therefore preferable to be able to configure the type of information that a sound message must actually generate within a communication peripheral 4. A configuration is therefore associated with each communication peripheral 4, so as to define the messages that, in terms of content, must actually trigger a sound within said communication peripheral 4. It is therefore proposed to avoid generating an acoustic voice message 7 within a communication peripheral 4 when the latter has been configured as not concerned with the information contained in the message and initially produced by the control center 3. The information flow between the control center 3 and the communication peripheral 4 is therefore specific to each communication peripheral 4 and defined in a configuration that is associated with it. Of course, it must remain possible, from the control center 3, to communicate messages that must be audible and therefore played by each of the communication peripherals 4, such as, for example, general alarms or messages from an operator managing the entire line 1 to each of the operators in charge of one or several stations 2.

The communication peripheral 4 is thus configured, for example, to process only information concerning a group 6 of stations 2, to process only messages concerning certain types of information, such as preventive maintenance, changes in supply, or else to process only messages reporting quantities processed by the stations 2, etc. The acoustic voice message 7 will thus be generated within a communication peripheral 4 only if, in accordance with its configuration, the information contained in the message is part of the information that said peripheral must make audible.

The communication peripheral 4 preferably comprises a programming graphic user interface, such as, for example, a touch surface making it possible for an operator 5 or for an installer to enter instructions for programming configuration, in this case instructions relative to the configuration of the communication peripheral 4. This interface is preferably arranged within the module 15, if applicable. By way of example, the communication peripheral 4 can, over a display screen, propose a list of the types of information possible, and the installer can then, by selecting, define those that must trigger the generation, by the communication peripheral 4, of an acoustic message. The definition of the configuration can, of course, be more detailed by allowing the installer the possibility of defining the information without being based on a pre-established list.

The configuration of each communication peripheral 4 is preferably stored within the control center 3, and, in absolute terms, the configurations of the different communication peripherals 4 can therefore be generated on a piece of equipment other than the peripherals themselves, such as, for example, a single central computer by the use of which all of the peripherals will be configured.

The specific configuration of the communication peripherals 4 has the effect of creating a network architecture of the client/server type, where each client, which the communication peripheral 4 forms, is identified specifically and the client/server relationship is thus specific to each client, taking into account the unique configuration of each communication peripheral 4.

The implementation of the configuration specific to each communication peripheral 4 then comes down to generating, within the server 8 of the control center 3, digital data dedicated specifically to each communication peripheral 4, such as in the form of a file coded in HTML, for example. The exchange of information from the control center 3 and to a communication peripheral 4 then consists essentially in the transmission to said peripheral of the data that are dedicated to it, and that have been generated for it within the server 8 on the basis of its individual configuration. The specific client/server relationship then takes the form of a subscription to an information flow, the content of which is generated as a function of the configuration associated with the receiving communication peripheral 4. There are then as many flows as different configurations, or even as communication peripherals 4.

The server 8 thus regularly collects data from the detection means 13 to monitor the operational state of the line 1. Logic calculations are used to analyze these data and to decide particularly, as a consequence, to communicate information to a particular communication peripheral 4 taking into account its configuration: alarm message, preventive maintenance information, information on the instantaneous operational status, etc. As a function of the data received and of the results of these calculations, files are then preferably generated within the server 8 to be exchanged via the specific subscription of each communication peripheral 4. These files, generated specifically for a communication peripheral 4 as a function of its subscription to a particular type of information, can be, for example, files coded in HTML format, to be easily read by a smart communication peripheral 4, equipped with an appropriate browser, such as a web browser. These files preferably directly contain the digital data for the production of a sound message by the communication peripheral 4 within its acoustic emitter 12, such as data representing a file in the MP3 format, for example, which will be read by the communication peripheral 4.

The file dedicated to the communication peripheral 4, once the latter will have received it from the server 8, will be read by it to produce an acoustic message, preferably an acoustic voice message 7, which can be audible to the operator who is in its immediate surroundings. Of course, multiple embodiments are possible for the data formats that are manipulated from the detection means 13 to the acoustic emitter 12:
the radiofrequency signal 9 can thus essentially be formed by the raw data noted by the detection means 13, the logic calculation then being ensured by the communication peripheral 4;
the radiofrequency signal 9 can intervene downstream from the generating of the MP3-type digital data for an acoustic signal, so that the radiofrequency signal 9 already conveys the digital file, the reading of which by the communication peripheral 4 will generate the audible sound;
the coded acoustic file, MP3 type, can be produced, for example, within the server 8, within the communication peripheral 4, or else within the acoustic emitter 12 itself, etc.

The signals sent by the control center 3 to the communication peripheral 4 can thus comprise the digital data necessary for the production of the acoustic message by the communication peripheral 4. This can include at least one audio digital file, such as, for example, a file that is coded and compressed with the MP3 protocol or the like. The radiofrequency signal 9 preferably represents a file that can be read by a browser software used on the communication peripheral 4, of the file type in HTML format, comprising the audio file. In this case, the audio digital file originates upstream from the radiofrequency transmission.

As has already been emphasized, it is advantageous to have recourse, ultimately, for supplying information to the operator 5, to an acoustic voice message 7. The acoustic voice message 7 produced by the communication peripheral 4 will therefore depend on the data noted on the line 1 as well as on the specific configuration of said peripheral. The digital file associated with the acoustic voice message 7 to be made audible in the vicinity of the acoustic emitter 12 of the communication peripheral 4 can thus originate from a bank of files, or be generated on demand, for example by voice synthesis. The first alternative makes it possible to have messages of good quality and with clear information, the second alternative making it possible to have information that is more specific and exactly representative of the situation, or messages that respond to specific requests from the operator 5, optionally after consultation with the database 11.

In the case of a pre-recorded acoustic voice message 7, the server 8 preferably comprises a catalog of digital files associated with such messages, and the results of the calculation that it performs on the basis of the data received by the detection means 13 make it possible to select from this catalog at least one digital file and to associate it with the data of the subscription of the different communication peripherals 4 as a function of their configuration. Here again, generally, the catalog of sound files can be stored in different locations of the exchange process.

Alternatively or in addition to these pre-recorded messages, it is conceivable to propose a step for creating digital data representing the acoustic voice message 7, by a tool of the voice synthesis type, following the calculation that the server 8 performs on the basis of the readings from the detection means 13. It is then possible to convey any type of information by means of a definitive acoustic voice message 7. Preferably, the file is created within the server 8 and is used within the files to communicate with the different communication peripherals 4 as a function of the configuration of their client subscription to the server 8. In absolute terms, the generation of a file of sound data can take place within the server 8 but also within the communication peripheral 4. The radiofrequency signal 9 can thus comprise the digital data of the file generated within the server 8, or can comprise the raw data, noted by the detection means 13, optionally selected as a function of the configuration of the communication peripheral 4, the generation of the digital file of sound data taking place then by said communication peripheral 4. The different steps of calculation and then of transformation of the information to arrive, ultimately, at an acoustic voice message 7 can thus be performed by different elements of the device. The data conveyed by the radiofrequency signal 9 can thus represent raw data, the results of a logic calculation on the basis of such data, criteria for finding a file in a library, a digital file coding sound, etc.

Taking into account what has been written, the invention makes it possible to generate acoustic messages, particularly acoustic voice messages 7, within a communication peripheral 4 as a function of its configuration and particularly of the readings taken on the line 1. The emission of an acoustic voice message 7 can therefore be triggered initially by events on the observed line 1, and taking into account rules of calculation and of communication configurations. As will be described, such an acoustic voice message 7 can also be generated in response to a request from the operator, using the communication peripheral 4. To do this, it is necessary to create a flow of information that is no longer from the server 8 to the communication peripheral 4 as has been described, but from the communication peripheral 4 to the server 8.

In this case, the communication peripheral 4 is, in addition, able to transmit a radiofrequency signal 9 in turn to exchange information. The control center 3, for its part, is able to receive such a radiofrequency signal 9 and to process it by a calculation logic. The information conveyed by the radiofrequency signal 9 can be an instruction for the server 8, for example, which will optionally be able to be passed on within the stations 2, a piece of information necessary for a calculation, a particular configuring. This information can also trigger a processing by the server 8, in the case of an instruction, of a request, or the like. This processing can take place, for example, by consulting the content of the database 11.

The flow of information from the communication peripheral 4 to the server 8 can take place in response to a prior flow in the opposite direction, or simply can initiate an exchange of information.

The communication peripheral 4 thus preferably comprises a microphone 14 so that the operator 5 can make acoustic voice messages 12 be audible. It is conceivable in particular that the acoustic voice messages 12 transmitted by an operator 5 using his communication peripheral 4 are received by at least one other communication peripheral 4, preferably all of the others, to make communication between the operators 5 possible. This communication can take place by sending the message data in advance to the control center 3, which then sends them to the other peripherals affected.

By way of example, the communication peripheral 4 comprises a man-machine interface that makes it possible for an operator to generate the information that will be sent by radiofrequency signal 9 to the communication base 10. It can be a touch surface, a keyboard, a cursor of the computer mouse type, etc. In configurations equipped in this manner, the microphone 14 makes it possible for the operator to interact not by touch but by voice. The processing is therefore the reverse of that described above, because an acoustic voice message 7 is received by the communication peripheral 4 and must be used, preferably by the server 8. It is therefore necessary to ensure an analysis of the acoustic voice message 7 received by the communication peripheral 4 to draw out from it the information that can be processed by a piece of digital equipment. This analysis and extraction, and then subsequent processing, can, of course, be performed at different locations:
the communication peripheral 4 can analyze the acoustic voice message 7, and transmit by radiofrequency signal 9 to the control center 3 only the data extracted, the data being processed then by the server 8;
the communication peripheral 4 can process the acoustic voice message 7 entirely, i.e., extract the data from it, perform a resulting logic calculation, and then generate in turn an acoustic voice message 7 in response;
the communication peripheral 4 can send a piece of information that represents only a digital coding in the form of an acoustic wave picked up by the microphone 14, the rest of the processing being provided by the server 8, etc.

It will be easily understood that, regardless of the solution adopted on this point, it is possible for the operator 5 to interact with the line 1, in both communication directions, or at least a portion of it, using acoustic voice messages 7, transmitted or received, that are of sufficiently weak sound volumes to be perceived only in the immediate surroundings of its source, namely either the operator himself, or the communication peripheral 4.

The signal feedback from the communication peripheral 4 to the server 8, as has just been described, can, of course, be followed by an exchange in reverse direction, from the control center 3 to the communication peripheral 4, and so on. The communication peripheral 4 can thus provide to the server 8 data necessary for a logic processing, also using, for example, the data from the database 11 for the subsequent generation of a responsive acoustic voice message 7 by the communication peripheral 4, on the basis of the operation described above.

In an advantageous embodiment, the communication peripheral 4 therefore comprises a connected smart device, or module 15, such as a smartphone, tablet or the like, or simply a computer, preferably equipped with an interface making it possible for an operator to send information, such as a touch surface, a cursor, or the like. This device communicates with the communication base 10, but also with the acoustic emitter 12, or satellite, which can be an ear piece, for example, and with which it is connected in a wired or wireless manner for signal transmission. This device also communicates, if applicable, with a microphone 14 with which the communication peripheral 4 is furnished. The microphone 14 and the acoustic emitter 12 can, of course, be encompassed within the same physical module, headphones type, for example. In these particular embodiments, the communication peripheral 4 itself takes the form of smart headphones, able to communicate with the communication base 10 in both directions, and therefore also equipped with a microphone.

The radiofrequency communication between, on the one hand, the communication base 10 and, on the other hand, the communication peripheral 4 preferably relies on a private network, of the WiFi Ethernet network type, which can be dedicated to this exchange between the control center 3 and the communication peripherals 4, or else which can be a radiofrequency network equipped for still other needs around the line 1.

The above description relates to both acoustic voice messages 7 and to acoustic non-voice messages.

As a result of the invention, it is thus possible to monitor with precision the operation of a multi-station industrial line for processing products, within the framework of which different messages must be communicated to different operators. This monitoring of operations, however, allows the operator the possibility to do other activities, and a specific communication is possible to each operator without bothering the others, which makes it possible to pass much more information without thereby creating a distracting work environment.

Although the description above is based on particular embodiments, it is in no way limiting of the scope of the invention, and modifications can be made, particularly by substitution of technical equivalents or by a different combination of any or part of the characteristics developed above.

1. Method for managing an industrial line (1) for chain processing of products comprising at least one processing station (2) and a control center (3) connected to at least one station (2), method comprising a step that essentially consists in collecting from at least one station (2) information that is representative of its operation and in communicating it to the control center (3), the method
comprising:
transmitting a radiofrequency signal (9) from the control center (3) and to a communication peripheral (4), and then
emitting a corresponding acoustic signal, using the communication peripheral (4),
the acoustic signal being dedicated to an operator (5) to whom said peripheral is assigned,
the information conveyed belonging to the communication peripheral (4).

2. Method according to claim 1, wherein
the acoustic signal transmission comes down to the reading, by the communication peripheral (4) and using a browser software, of a digital file adapted to such software and exchanged with the control center (3).

3. Method according to claim 1, where
the acoustic signal is obtained by selection from a library of pre-recorded messages in the form of encoded digital files, representing acoustic messages, particularly in the form of acoustic voice messages (7).

4. Method according to claim 1, where
the acoustic signal emitted by the communication peripheral (4) to the operator (5) who is wearing it is an acoustic voice message (7).

5. Method according to claim 1, where
the acoustic signals that are emitted by the communication peripheral (4) depend on a configuration that is specific to it and that defines the type of information from which the signal must be identified to be acoustically produced and thus be audible to the operator (5) with whom the communication peripheral (4) is associated.

6. Method according to claim 5, where
defining the configuration of the communication peripheral (4) takes place using an interface with which it is itself equipped.

7. Method according to claim 5, where
the configuration of the communication peripheral (4) is stored within the control center (3).

8. Method according to claim 1, where
the communication peripheral (4) is an identified client, in association with a server (8) of the control center (3), the server (8) generating a flow of information relating to the line (1) and that is specific to the communication peripheral (4).

9. Method according to claim 1, further comprising a step consisting essentially in sending a message by radiofrequency signal (9) from a communication peripheral (4) and to the control center (3).

10. Method according to claim 9, further comprising a step consisting in analyzing an acoustic voice message (7) produced by an operator (5) bound for the communication peripheral (4), to create the content of the radiofrequency signal (9) sent by the communication peripheral (4) to the control center (3).

11. Method according to claim 9, where the content of the message sent by the communication peripheral (4) to the control center (3) is created from an interface with which the communication peripheral (4) is equipped.

12. Device for monitoring a line (1) for chain processing of products with at least one processing station (2), comprising a control center (3) for at least collecting data relating to the processing by at least one station (2) and a database (11) for storing at least data representative of the operation of the processing line (1),
wherein
the control center (3) comprises a signal communication base (10), to at least transmit radiofrequency signals (9) concerning information relating to the line (1),
the monitoring device further comprises at least one communication peripheral (4), to receive from said communication base (10) a radiofrequency signal (9), said communication peripheral (4) being provided with an acoustic emitter (12) to make messages concerning the operation of the line (1) audible, and this in a targeted way to a line operator (5) to whom said peripheral is assigned.

13. Device according to claim 12, where
the communication peripheral (4) comprises a module (15) in the form of a communicating smart digital device, equipped with a processor and able to exchange wireless signals with the control center (3), using a network or web browser software tool to read corresponding digital files exchanged with the control center (3), as coded in HTML, with audio message digital data.

14. Installation for chain processing of products comprising a series of stations (2) forming a processing line (1), the stations (2) being associated in groups (6) each comprising at least one station (2),
further comprising a monitoring device according to any one of claim 12, the control center (3) of which is connected to the stations (2) of the line (1) to collect and analyze data relative to their operation within a server (8) that comprises said central processor,
said monitoring device being equipped with a plurality of communication peripherals (4).

15. Installation according to claim 14, where a specific configuration is associated with each communication peripheral (4) and determines the type of message exchanged between it and the server (8) or a server (8) of the control center (3).

16. Method according to claim 2, where the acoustic signal is obtained by selection from a library of pre-recorded messages in the form of encoded digital files, representing acoustic messages, particularly in the form of acoustic voice messages (7).

17. The method of claim 4, wherein the acoustic voice message (7) is obtained by artificial voice synthesis within the control center (3) or even within the communication peripheral (4).

18. The method of claim 4, wherein the acoustic voice message (7) is obtained by artificial voice synthesis within the communication peripheral (4).

19. Method according to claim 2, where the acoustic signals that are emitted by the communication peripheral (4) depend on a configuration that is specific to it and that defines the type of information from which the signal must be identified to be acoustically produced and thus be audible to the operator (5) with whom the communication peripheral (4) is associated.

20. Method according to claim 3, where
the acoustic signals that are emitted by the communication peripheral (4) depend on a configuration that is specific to it and that defines the type of information from which the signal must be identified to be acoustically produced and thus be audible to the operator (5) with whom the communication peripheral (4) is associated.
